(19) United States
(12) Patent Application Publication
(10) Pub. No.: US 2007/0253629 A1
(43) Pub. Date: Nov. 1, 2007

(54) Image Processing Device and Image Forming Device Provided therewith

(76) Inventors: Hiroyuki Oshio, Tokyo (JP); Keita Kamiya, Tokyo (JP); Shinobu Fujikura, Tokyo (JP)

Correspondence Address: GLENN PATENT GROUP, 3475 EDISON WAY, SUITE L, MENLO PARK, CA, 94025, US

(21) Appl. No.: 11/740,111

(22) Filed: Apr. 25, 2007

(30) Foreign Application Priority Data
Apr. 26, 2006 (JP) 2006-121438

(51) Int. Cl. G06K 9/46

(52) U.S. Cl. 382/240

(57) ABSTRACT

The present invention is provided with a wavelet conversion means 115 for performing a wavelet conversion process of either of the number of lines 1 to 4 for image data, a prediction difference means 116 for performing a prediction difference process to the minimum frequency subband of a plurality of subbands obtained by the wavelet conversion process 115, a range coder encoding means 117 for performing an entropy encoding process to the respective subbands obtained by the wavelet conversion process based on a result of the prediction difference process, and a decode processing portion 120, in which the image data is reconstructed from the code obtained by the entropy encoding process.

### BACKGROUND OF THE INVENTION

1. Field of the Invention

The present invention relates to an image processing device and an image forming device provided therewith, and in particular, relates to an image processing device for image encoding and an image forming device provided therewith.

2. Description of the Related Art

Conventionally, as one of the image compression methods, there is a standard called JPEG 2000 in an image encoding technology. According to http://e-words.jp/w/JPEG 2000.html and such, JPEG 2000 is a standard for defining a method of compression and development, which may perform high-compression with high-quality.

In JPEG 2000, a disintegration wavelet conversion process is conducted for conversion of an image from a spatial region to frequency domain once. The disintegration wavelet conversion process stands for a conversion method for quantizing, encoding and further compressing each of vertical and transverse frequency components, in which the entire image is divided into the frequency band by the wavelet function. According to this conversion, lossy compression may also be performed. Furthermore, according to the conversion, neither a block noise (a grid-like noise) nor a mosquito noise (a noise like a ripple on a water surface) occurs even if the image is stored with high compression ratio (low image quality).

Further in JPEG 2000, an entropy encoding process is conducted via the quantization process for an image converted to the frequency region from the spatial region. For the encoding process, EBCOT (Embedded Block Coding with Optimized Truncation) encoding process is adopted.

Prior Non Patent Document: http:H/e-words.jp/w/JPEG 2000.html

### DISCLOSURE OF THE INVENTION

### Problems to be Solved by the Invention

However, although in JPEG 2000, high compression with high quality for image is realized by adopting the disintegration wavelet conversion process and EBCOT encoding process and such, either of these process has problems with respect to much operation amount and speedup of the compression process.

To be concrete, in JPEG 2000, in case of the disintegration wavelet conversion process, wavelet conversion by scanning 5-7 lines is performed. In general, the more the number of lines increases, the more it becomes possible to reduce the compression rate, but the operation time becomes long.

Therefore, typically, in case JPEG 2000 method being adopted, it is impossible to realize lossless compression animation, so it was required to increase relatively the memory capacity and the number of the memory sheets that stores the image.

Now, the problem to be solved by the present invention is to reduce compression process time while realizing high compressive and high quality image compression.

To solve the above-described problem, the image process device of the present invention is provided with:

a wavelet conversion means for conducting a wavelet conversion process for image data with 16 pixels at the maximum in 1-4 lines adjacent each other to the image data,

a prediction difference means for performing a prediction difference process for the subband with minimum frequency of a plurality of subbands obtained by the wavelet conversion process, and

an encoding means for performing an entropy encoding process for each subband obtained by the wavelet conversion process based on a result of the prediction difference.

That is to say, according to the present invention, the wavelet conversion is performed to the image data, for instance, 16 pixels in total with 16 columns per 1 row, 16 pixels in total with 8 columns per 2 rows, 16 pixels in total with 4 columns per 4 rows, 16 pixels in total with 2 columns per 8 rows, 16 pixels in total with 1 column per 16 rows, or to the image data in which some pixels are excluded from them.

In addition, the wavelet conversion means may be also provided with a selection means for selecting the number of lines.

Furthermore, the selecting means determine the number of lines based on information whether the image data is an animated or still image, and information indicating whether the compression ratio of the image data is wanted to be equal to or less than the predetermined value or not.

Still further, the present invention is provided with reconstruction means for reconstructing the image data from codes obtained by the encoding process.

The image forming device has the above-described image processing device.

### EFFECT OF THE INVENTION

The present invention more particularly realize totally incomparable compression time of about 0.03 seconds to 0.08 seconds at the maximum even if at lossless time (i.e., when 1 line is wavelet converted) in case of compression process with JPEG 2000, if compression process is performed by the image processing device of the present invention for the image which needs compression time of about 2 seconds.

Therefore, for instance, the storage number of the still image with high quality for memory can be increased, which is a distinguished result when the image for compression is a still image. In addition, lossless compression animation can be also realized, which is a distinguished result when the image for compression is an animated image.

### PREFERRED EMBODIMENTS OF THE INVENTION

Hereinafter, embodiments of the present invention will be described referring to the accompanying figures.

FIG. 1 is a block diagram showing a patterned configuration of image processing device 100 of the embodiment of the present invention. As shown in FIG. 1, the image processing device 100, the image processing device 100 is roughly classified into an encode processing portion 110 and a decode processing portion 120. The container 130 is not necessarily provided with the image processing device 100 itself. For instance, the container 130 may be a removable memory to the image processing device 100.

The encode processing portion 110 is provided with tile division means 111, transfer means 112, DC level shift means 113, color conversion means 114, wavelet conversion means 115, prediction difference processing means 116 and range recorder encoding means 117, all of which will be explained hereinafter.

The tile division means 111 is a means for dividing the image of compression process target into the tile size. In addition, the tile division means 111 divides the tile in the size designated by an end user at relative points which are same for each component. The designated size is stored in a memory and such. The tile component is encoded independently each other and becomes a basic unit of the encoding process. The number of the following each action is the same as the number of tiles. Also, an input source of the image which compression should be performed may be, for instance, an image input section which generates and inputs the image data, an imaging device such as a scanner and a digital camera, a device in which the image data is read out from a storage medium where the image data is memorized, and further an interface which receives the image data from the communication line and such and then inputs it, and such.

Transfer means 112 is a means for transferring respectively the tile component to the internal bit maps for every tile divided by the tile division means 111. In the status quo, the number of component is most commonly 3, i.e., for RGB, however, 4 such as for RGBE and more numbers are possible. By the above transfer process, a process for storing the encoded code in the container 130 will be performed for the internal bit map.

The DC level shift means 113 is a means for performing a DC level shift where a half of the dynamic range of each of the tile components is subtracted when the signal value of each of the tile components transferred by the transfer means 112 is an integer without any sign like RGB signals. As one example, when the image data is a bit map with 24 bit, and there are 3 components (RGB), the DC level shift means 113 shifts each component to a “−127 to 127” level where the average value is set, for instance, to “0” since each component is represented by 8 bit integer of “0 to 255” without sign. In fact, if the image subject to be compressed is YCbCr signal and such, the present process by the DC level shift means 113 may be skipped.

Color conversion means 114 converts a color space of each of the tile components to an integer with a sign like a YCbCr color space from an integer without a sign such as the RGB color space. For the conversion, either of a reversible conversion such as RCT (Reversible multiple component transformation) or an irreversible conversion such as ICT (Irreversible multiple component transformation) may be used. In fact, if the image subject to be compressed is YCbCr signal and such, the actual process by the DC level shift means 113 may be skipped.

The wavelet conversion means 115 performs a line-based wavelet conversion for buffering the image data for 1-4 lines, vertically filtering it, and then horizontally filtering the data column obtained by the above. As an alternative, after the vertical and horizontal filtering, the wavelet conversion (block-based wavelet conversion) is performed to the image data in the both directions. In the present embodiment, the number of line is set to either of 1 to 4.

The wavelet conversion means 115 is provided with a selection means for selecting the number of line based on information whether the image subject to be compressed is animated or still image, and whether the compression rate of the image data is desired to be, for instance, equal to or less than 50% or not. The selection means is conceptually arranged to select
1 line 1 if the image subject to be compressed is an animated image and the compression rate is equal to or less than 50%,
2 lines if the image subject to be compressed is an animated image and the compression ratio is not equal to or less than 50%,
3 lines if the image subject to be compressed is a still image and the compression rate is equal to or less than 50%, or
4 lines if the image subject to be compressed is a still image and the compression rate is not equal to or less than 50%.

A line called here stands for either one of row or column where the pixel is disposed in a matrix. Therefore, it should be noted that the line does not show only the row or the column.

Furthermore, the selection means is provided with, for instance, a table memory for storing the correspondence between the image subject to be compressed and the above-described number of the lines, a first judgment means for judging whether the image subject to be compressed is a still image or animated image based on an attribute information added to the image subject to be compressed, a second judgment means for judging whether the compression rate of the image subject to be compressed directed by an end user is, for example, equal to or less than 50% or not, and a determination means for determining the number of lines of the wavelet conversion by referring to the above-described table memory based on results judged by the first and the second judgment means.

In fact, instead of selecting the number of line of the wavelet conversion by the above-described selection means, a user may select the specific number of line, or the selection process itself may be evaded and a wavelet conversion process with the fixed number of line may be performed. The memory not shown in the figures stores information on the specific number of line selected by the user, or information on whether or not the compression rate of the image subject to be compressed directed by the end user and referred by the above-described second judgment means is, for instance, equal to or less than 50%.

By the wavelet conversion, each of the tile components are divided into 4 subbands, respectively, i.e., a horizontal low pass vertical low pass (LL) band, a horizontal low pass vertical high pass (HL) band, horizontal high pass vertical high pass (LL) band. Furthermore, for instance, as for the horizontal low pass vertical low pass (LL) band, is divided into 4 as well, and then is divided into 7 subbands in total by adding LL-LL band, LL-HL band, LL-LH band and LL-HH band. In fact, further subdivision such as dividing the LL-LL band further is possible. The degree of subdivision may be determined by end users based on a size of image data.

Prediction difference process means 116 is a means for performing prediction difference process to a LL-LL band which is a subband of minimum frequency of image obtained by the wavelet conversion means 115. The prediction difference process predicts error (relative value) showing sifted amounts of an arbitrary pixel or an arbitrary line which are encoded (typically a pixel in 1 row 1 column or a first line) against the other pixel or the other line, and encodes the difference between the predicted result and the actual pixel value or line value. Alternatively, it is possible to predict difference between pixels (or lines) adjacent to each other, such as difference between a pixel of 1 row 1 column and a pixel of 1 row 2 column, difference between a pixel of 1 row 2 column and a pixel of 1 row 3 column, and difference between a pixel of 1 row 3 column and a pixel of 1 row 4 column and such, and to perform above-described encoding. Of course, the prediction difference process is not restrictive, and it is possible to employ various methods such as performing the process using the peripheral pixels, and so on.

Range coder encoding means 117 is a means, in which entropy encoding is performed using a range recorder for the 6 subbands except for LL-LL band in each of the 7 subbands obtained by the wavelet conversion means 115, and further entropy encoding is performed using the range coder based on the prediction difference process result by the prediction process means 116 for the LL-LL band. In addition, the encoding method is not limited to the range coder encoding, but may adopt Huffman coding, another arithmetic encoding and such. In addition, detailed content of the range coder encoding, is described in, for instance, “From the beginning to the application of data compression” in “C magazine, July 2002” by Haruhiko Okumura for reference.

In addition, the code, in which range coder encoding is performed by the range coder encoding means 117 is stored in a container 130.

A decode processing portion 120 is provided with range coder encoding means 121, storage means 122, prediction difference reconstruction means 123, wavelet inverse transformation means 124, color inverse transformation means 125, DC level shift means 126 and tile composition means 127, which will be explained hereinafter.

These respective means 121 to 127 perform reverse process of the process performed by either of the above-described respective means 111 to 117 as well as a general compression-reconstruction process of image.

The range coder encoding means 121 is means for reading out codes stored in the container 130 and performing a range coder encoding. The process will also be described in “From the beginning to the application of data compression” in “C magazine, July 2002” by Haruhiko Okumura for reference.

The storage means 122 is means for storing each subband encoded by the range coder encoding means 121 in the internal bit map. By the storage process, the process for outputting image not compressed from the image process device 100 will be performed setting the internal bit map as a subject.

The prediction difference reconstruction means 123 is means for reconstructing the prediction difference of the minimum frequency subband in the respective subband stored by the storage means 122.

The wavelet reverse transformation means 124 is means for performing the wavelet reverse conversion to reconstruct each of the tile components composing each of the subbands.

The color reverse transformation means 125 is means for reversely converting each of the tile components to integers without a sign s like a RGB signal in case the conversion process by the color reverse transformation means 125 is performed.

The DC level shift means 126 is means for performing the DC level shift, that is, for adding a half of dynamic range of the respective tile components reversely converted by the color reverse transformation means 125 when the DC level shift is performed by the DC level shit means 113.

The tile composition means 127 is means for reconstructing images compressed by composing each respective tile component DC level shifted by the DC level shift means 126.

In addition, for instance, the encrypted compression encoding data may be generated by encrypting the image data before the entropy encoding process. Preferably, the encryption process may be performed after the entropy encoding process. In addition, embedding of water mark may be performed, if necessary. Preferably, the embedding process may be performed after the range coder encoding process.

The image processing device 100 can be provided with an imaging device such as a digital camera. In case the image processing device 100 is provided with the imaging device, the imaged image can be encoded and stored to a storage medium (the container 130) such as a removable memory to the imaging device.

The image processing device 100 may also be provided with a printing device, by which the image is printed on the storage medium based on the printed data which is output from such as a personal computer. In this case, the printed image data output from such as the personal computer is divided into a tile unit, compressed and encoded by performing the wavelet conversion and such in the image processing device 100, and then stored successively into the container 130. In addition, for instance, the image processing device 100 may be provided with a means for adjusting the tile size depending on the size of image data to be printed. Thereafter, the printing means in the printing device in turn decodes and prints the encoded data stored in the container 130.

Further, the image processing device 100 may also be provided with a cellular telephone, a PDA, a satellite image, an image extension device for medical image and such. Also in such case, it is possible to compress and store the image. That is to say, the image processing device 100 is applicable as far as it is a device which can form an image, even if it is a device like an imaging device whose main aim is to input the image, or even if it is a device like a printing device whose main aim is to output the image, or even if the device can perform both of the above-described main aims.

FIG. 2 and FIG. 3 are explanatory diagrams of the operation of the image processing device 100 shown in FIG. 1. Hereinafter, an example with respect to the image processing device 100 provided with a digital camera will be explained.

At first, a user, if necessary, selects information whether the number of line targeting the wavelet conversion should be a specific number of line, for example it should be equal to or more than 50% or not, and sets it to the digital camera. This kind of information is stored into the memory not shown in the figures in the image processing device 100. In this state, if the user pushes down an electronic shutter of the digital still camera, light from the subject is taken into the digital camera. This light is condensed onto such as a CCD sensor or a CMOS sensor by a condenser lens. In the CCD sensor and such, the light is converted into an electric signal, thereby an image data is generated. In case of the CCD sensor, the image data is transferred into the data memory which is an accumulation medium. On the other hand, in the case of the CMOS sensor, the image data is accumulated into the internal condenser and such.

Next, the image data accumulated in the memory and such, is converted into a digital signal from an analog signal by an A/D converter, and then is input to the image processing device 100. The image processing device 100 distinguishes periodically whether there is an image input or not, in case the main power is ON (Step S1).

The image processing device 100 completes a process shown in FIG. 2 and waits for the next above-mentioned distinction process, in case there is no longer image input as a consequence of the distinction. On the other hand, if there is an image input, the tile division means 111 divides the input image data into the predetermined size, and outputs it into the transfer means 112 (Step S2).

The transfer means 112 divides the image data into the respective tile components and transfers the image data into the internal bit map if the image data divided by the tile division means 111 is input (Step S3). Afterwards, respective processes described as follows are performed with respect to the internal bit map.

The DC level shift means 113 judges whether the signal values of the respective tile components transferred to the bit map by the transfer means 112 are integers without signs or not (Step S4). As a result of the judgment, if the signal values of the respective tile components are not the integers without signs, the process shifts to Step S6. On the contrary, if the signal values of the respective tile components are the integers without signs, the DC level shift process is performed to convert the above-mentioned signal values to the integers with signs (Step S5).

Next, the color conversion means 114 judges a conversion necessity of color space of the respective tile components to enhance a compression rate of image data (Step S6). Here, typically, it is judged that the color space of the respective tile components is needed to be converted if it is the RGB color space, the RGBE color space, the CMYK color space, while it is judged that such conversion is unnecessary if the color spaces of the respective tile components are the color spaces like a monochrome image. As a result of the judgment, if conversion of the color space is necessary, the integer without sign is converted into the integer with sign (Step S7). In addition, if necessary, not only the color conversion but also brightness conversion may also be performed.

The wavelet conversion means 115 selects the number of lines for scanning, performs a wavelet conversion process with the number of line, and then obtains 7 subbands in total (Step S8).

In the embodiment, for instance, the wavelet conversion process is performed with the subroutine shown in FIG. 3 as follows. That is to say, at first, information set by user, which is set in a memory not shown in the figure, judges whether the specific number of line is shown or not as the number of line targeting the wavelet conversion (Step S21).

As a result of the judgment, if a specific number of lines are selected, the number of line is set (Step S29) and the process is then shifted to Step S9. That is to say, in the Step S29, the wavelet conversion is performed to the selected specific number of line even if the image is an animation or a still image; on the contrary, if the specific number of line is not selected, it is judged whether the image targeting the wavelet conversion process is an animation or not (Step S22).

As a result of the judgment, the content selected by the user judges whether the compression ratio of image data should be set to equal to or less than 50%, despite whether the image targeting the wavelet conversion process is an animated image or not (Step S23, S26).

As a result of the judgment in the Step S22, and S23 or S26, the number of lines is set to “1”, if the image targeting compression is an animated image and the compression ratio is equal to or less than 50% (Step S24), the number of lines is set to “2” if the image subject to be compressed is an animated image and the compression ratio is not equal to or less than 50% (Step S25), the number of lines is set to “3” if the image subject to be compressed is a still image and the compression ratio is equal to or less than 50% (Step S27), the number of lines is set to “4” if the image targeting compression is a still image and the compression ratio is not equal to or less than 50% (Step S28), then the process shifts to Step S9.

The prediction difference process means 116 calculates an error of another dots, for instance, for a dot at 1 row 1 column of the subbands of the minimum frequency obtained by the wavelet conversion means 115, and then outputs the error into the range coder encoding means 117 (Step S9).

The range coder encoding means 117 performs a range coder encoding based on an error calculated by the prediction difference means 116 for each of the 7 subbands obtained by the wavelet conversion means 115, and stores the codes obtained as a result into a removable memory which is the container 130 (Step S10). In this manner, the image processing means 100 compresses and stores the image data which is input (Step S11). In addition, as described above, the encryption process may be performed after the entropy encoding process and such.

Next in the image processing means 100, in case the compressed image is reconstructed, at first, the range coder encoding means 121 reads out codes stored in the container 130 (Step S12), obtains the respective subbands by decoding the range coder, and outputs the subbands to the storing means 122. In addition, as described above, the embedding process may be performed after performing the range coder encoding process and such.

The storing means 122 stores the respective subbands decoded by the range coder decoding means 121 in the internal bit map (Step S13).

The prediction difference reconstruction means 123 reconstructs the prediction error difference of the minimum frequency subband of the respective subbands stored by the storing means 122 (Step S14).

The wavelet reverse transformation means 124 composes the respective subbands and performs the wavelet reverse transformation to reconstruct the respective tile components (Step S15).

The color reverse transformation means 125 judges whether it is converted to an integer with a sign of YCbCr signal and such by the color conversion means 114 (Step S16). As a result of judgment, if it is not converted to the integer with the sign, the process is shifted to Step S18; on the other hand, if the signal is converted to the integer with the encode, the respective tile components are reversely converted into an integer without a sign such as the RGB signal, etc (Step S17).

The DC level shift means 126 judges whether the DC level shift process is performed by the DC level shift means 113 or not (Step S18). If the DC level shift process is not performed, the process is shifted to Step S20. On the other hand, if the DC level shift process is performed, the DC level shift is performed, in which a half of the dynamic range of the respective tile components is added (Step S19).

The tile composition means 127 reconstructs the image which has been compressed by composing the respective tile components (Step S20).

### BRIEF DESCRIPTION OF ACCOMPANYING DRAWINGS

FIG. 1 is a block diagram showing a schematic configuration of the image processing device 100 of the embodiments of the present invention.

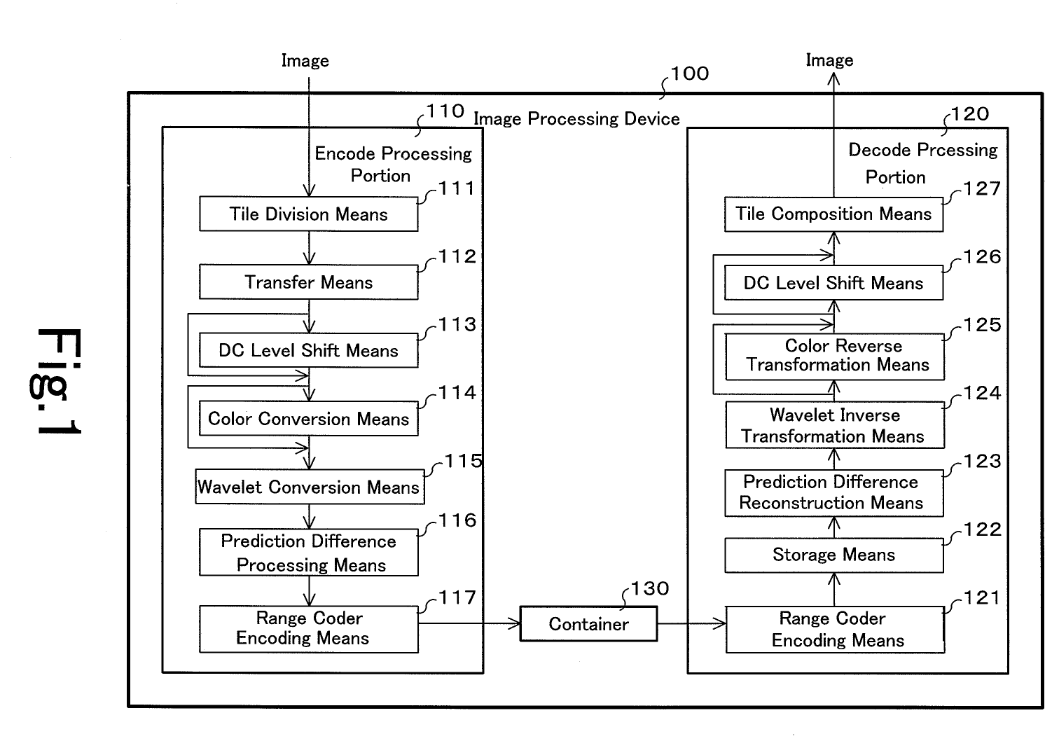

FIG. 2 is an explanatory diagram of an operation of the image processing device 100 in FIG. 1.

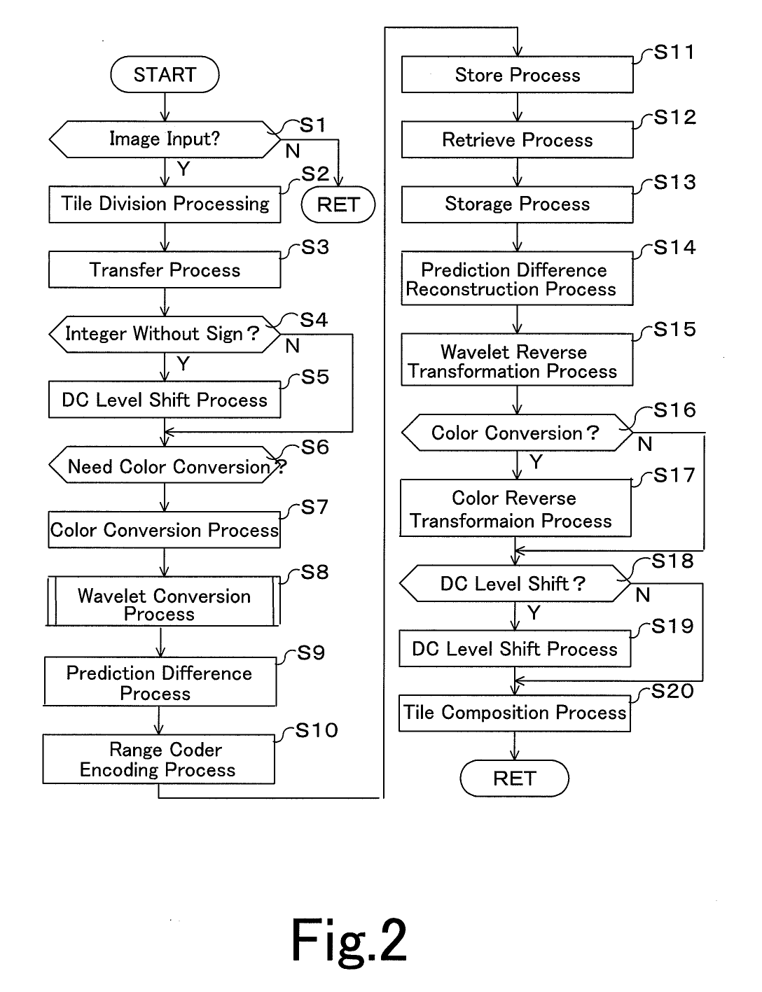

FIG. 3 is a diagram of subroutine of Step S8 in FIG. 2.

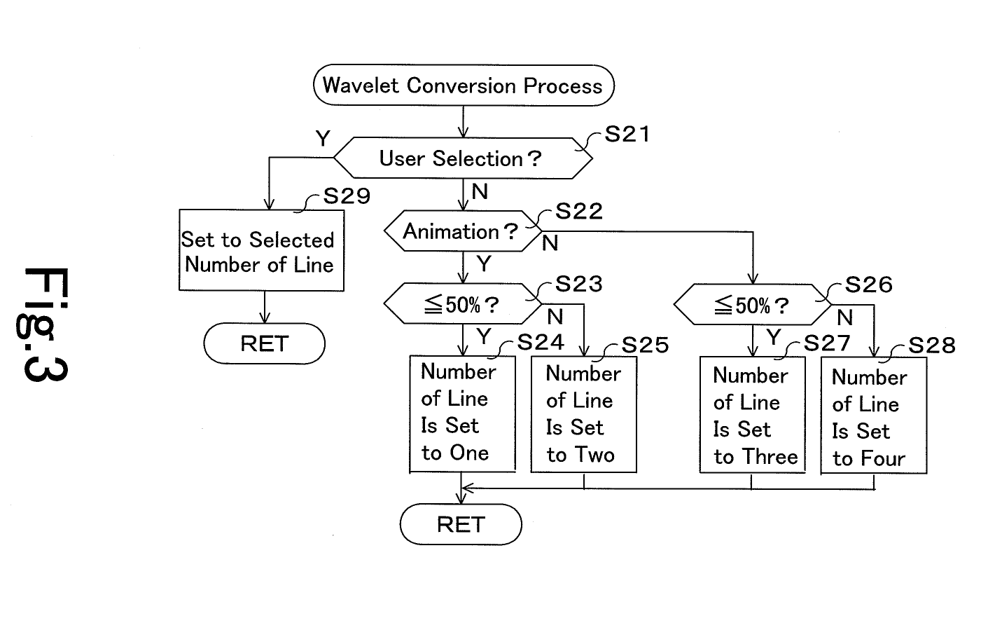

1. An image processing device comprising:
a wavelet conversion means for performing a wavelet conversion process of image data of 16 pixels at the maximum in line numbers 1 to 4 adjacent to each other of the image data;
a prediction difference means for performing prediction difference process for a minimum frequency subband of a plurality of subbands obtained by the wavelet conversion process; and
an encoding means for performing an entropy encoding process to respective subbands obtained by the wavelet conversion process based on a result of the prediction difference process.

2. The image processing device as claimed in claim 1, wherein the wavelet conversion process comprises a selection means for selecting the number of lines.

3. The image processing device as claimed in claim 2, wherein the selection means determines the number of lines based on information showing a distinction between an animated image and a still image of the image data and whether a compression rate of the image data is desired to be equal to or less than a predetermined value or not.

4. The image processing device as claimed in any of claims 1 to 3 comprising a reconstruction means for reconstructing the image data from a code obtained by the encoding process.

5. The image forming device having the image processing device as claimed in any of claims 1 to 4.
